(19) United States
(12) Patent Application Publication
(10) Pub. No.: US 2005/0286145 A1
(43) Pub. Date: Dec. 29, 2005

(54) Invention concerning a condensor lens

(75) Inventors: Franz Silhengst, Ollern (AT); Alexander Di Otto, Bisamberg (AT)

Correspondence Address: Merchant & Gould P.C., P.O. Box 2903, Minneapolis, MN, 55402-0903, US

(73) Assignee: SWARCO FUTURIT Verkehrssignalsysteme Ges.m.b.H.

(21) Appl. No.: 10/966,938

(22) Filed: Oct. 15, 2004

(30) Foreign Application Priority Data
Jun. 25, 2004 (AT) A 1086/2004

(51) Int. Cl. G02B 3/08

(52) U.S. Cl. 359/742

(57) ABSTRACT

A condenser lens for generation of essentially parallel light beams, in which the condenser lens (8) curves essentially in the form of a shell around its focal point (F) and has, at least in one region (27) on the inside (20) of the shell, a Fresnel structure in the form of teeth (16) that are bounded by light inlet surfaces (14) and reflection surfaces (15). In the region (27), the outside (21) of the shell has gradations formed from outlet surfaces (18) and connecting surfaces (19), in which the outlet surfaces (18) are aligned essentially normal and the connecting surfaces (19) that join the adjacent outlet surfaces (18) are aligned essentially parallel to the optical axis (2). The slope and position of the reflection surfaces (15) of teeth (16) are established, so that an imaginary boundary light beam (6a), coming from focal point (F) and touching the tooth edge (22) of the preceding tooth, touches the indentation base (23) after refraction on the inlet surfaces (14) or encounters the reflection surface (15) in its immediate vicinity and runs parallel to the optical axis (2) after its reflection.

The invention concerns a condenser lens to generate essentially parallel light beams from a light source provided at least close to the optical axis of the condenser lens.

In the first LED traffic signals, several hundred LEDs were uniformly distributed over the signal surface in order to produce uniform brightness. With the arrival of less expensive super-bright, high-performance LEDs, this design had to be modified, since the small number of such LEDs no longer permitted a uniform appearance. Consequently, a central light source was formed similarly to the previous incandescent lamp with a compact arrangement of the LEDs and the light distributed by optical means over the entire signal surface. The means ordinarily consists of a condenser disk with Fresnel optics mounted in front, which collects the light of the LED and bundles it essentially parallel, comparable to the earlier reflector, and a diverging lens, which distributes the bundled light as before according to different standardized specifications.

Not only is this design more cost-effective, due to the small light source structure, as well as its low replacement costs, but also the electronic circuitry with a few high-performance LEDs is simpler and more favorable to resolve from a safety standpoint than the circuitry of many dozens of LEDs.

The signals with distributed LED arrangement possess a very limited design depth and are very uniform in appearance, but the individual LEDs stand out as luminous points. In contrast, the appearance of signals with a central LED arrangement is very uniform, but much brighter in the middle region than toward the edges, and are therefore comparable to the earlier incandescent lamp-reflector solution. The reason for this is that the outer edges of the bundling optics are much farther from the light source than the center, and therefore much less light reaches them, because the intensity of the light, as is known, diminishes with the square of distance from the light source.

Whereas in the old system (incandescent lamp-reflector) this effect was or had to be tolerated, there are now simple possibilities for improvement. On the one hand, a relatively large design depth might reduce the relative differences in distance of the LEDs from the signal disk. This type of signal insert, however, would no longer fit into signal housings.

On the other hand, the emitted light of the LEDs already has a distribution such that the edge of the condenser disk is illuminated much more brightly than the center. The so-called batwing distribution is involved here. (In the light distribution diagram, the brightness increasing toward the edge looks like the outline of the outstretched wings of a bat.) Unfortunately, this type of light distribution is not generally usable, for which reason it is only offered by very few LED producers.

In the third place, the condenser disk can be configured much more freely than the previous reflector, so that the brightness distribution can be more uniform. This is possible to the extent that the condenser disk need not be flat, but can also have a curved, more or less shell-like shape, as long as the light-collecting properties are not thereby hindered. Certain shifts in brightness distribution are possible by this curvature.

Because LED sales in signaling account for only a limited percentage of the total market, LED producers have no interest in producing special types. It is therefore desirable to construct such a central light source from generally available universal types. LEDs with a “Lambert” or “cosine distribution” would work here, in particular. The light distribution appears as a cosine curve in an intensity plot/emission angle diagram, which has its maximum at the optical axis and no longer emits light 90° laterally. This distribution also corresponds to a flat Planck radiator, and the LED chip itself, for processing reasons, represents a plane that emits in all directions. An LED with a cosine distribution therefore generally represents only the flat or hemispherical encapsulation of the components produced by casting without integration of a special light guidance, the configuration of a required light distribution being left fully to the user, since otherwise there would have to be an unmanageably large number of lens shapes and sizes. The high-performance LEDs in particular are offered in such shapes, since they also have favorable efficiency.

It would therefore be desirable to configure a condenser lens using LEDs with a cosine distribution, so that the diffusing lens situated in front has only limited brightness differences between the edges and the center, so that the pertinent standards relative to light density ratio, which the brightness differences are called, would be met. These stipulate a maximum admissible ratio of largest to smallest specific brightness in the axial direction.

A theoretical solution to the problem of uniformity is known. A condenser lens in a hemispherical configuration and 100% efficiency with the LED at its center point exactly meets this requirement, so that no brightness differences occur. Since the distance of the LED to the condenser lens is constant, the light diminishing outward according to the cosine function is condensed by the circular curvature toward the edges and the brightness drop is thus mathematically compensated for precisely.

Unfortunately, on the one hand, this type of condenser lens cannot be produced in practice, because of implementation of the mentioned light compaction, and, on the other hand, it would also be too large, since the signal insert would no longer fit in any available housing as a hemispherical shape with diverging lens diameter. However, it is recognizable, because of this, that the condenser lens should curve as sharply as possible around the LED.

Cost-effective production of the condenser lens requires one-piece geometries that ideally can be shaped without special tools directly from transparent plastic and require no surface treatment, like partial mirroring or varnishing.

Previous variants use a flat condenser disk that has a specific spacing from the LED arrangement, and whose radius is slightly larger than this distance. The brightness differences still remain in the admissible range, but about half the light from the LED is lost with cosine emission, which is not economically acceptable. In particular, the aforementioned LED with batwing distribution is used in such signals.

Another variant is extensively used in the field of vehicle lights. Condenser disks are sometimes used here, whose radius is much greater than the spacing to the light source. However, mostly the use of two different light guidance systems is necessary: first, a light-refracting Fresnel element in the center, and second, totally reflecting Fresnel elements farther out. The curvature of the condenser disk is variable within limits and can even directly form the smooth outer disk of the signal light if the Fresnel elements are all arranged on the interior. The brightness ratio, however, is correspondingly unfavorable here.

A third known variant of the applicant is a condenser disk in subordinate signal lights. This is already curved around the LED. In the center, it is smooth on the side of the light source and the light-refracting Fresnel structure is applied to the other side. A reflection structure is then placed on the inside of the curvature and the outside of the curvature is smooth. The condenser disk already uses the largest part of the LED light, emitted in cosine form, but the brightness differences on the signal surface are still somewhat too large.

An improvement of this variant is therefore sought for general use in signals.

The problem of the invention is to configure a condenser lens, using LEDs with cosine distribution, so that a diverging lens located in front has only limited brightness differences between the edges and the center, so that the pertinent standards with reference to light density ratio are satisfied. The highest possible light efficiency is naturally required.

This problem is solved according to the invention in that, overall, the condenser lens curves shell-like around the light source and almost completely captures its light, in that the reflection elements face the light source and consist of an inner surface parallel to the axis as light entry surface and a sloping reflection surface directly adjacent to the end on the light source side, whose inclination deflects the incident light beams by total reflection exactly in the axial direction, and these elements are adjacent to each other without gaps, and that the light outlet surfaces face away from the light source and are flat, perpendicular to the optical axis and connected by connection surfaces parallel to the axis.

This variant permits stronger curvature around the LED, without loss of efficiency or parallelism of the light. The relative spacing differences of the LED to the condenser lens are therefore lower, as are the brightness differences, so that the standard can be met. Simple mold release is also guaranteed.

The invention will now be further explained with reference to the figures. Shown are

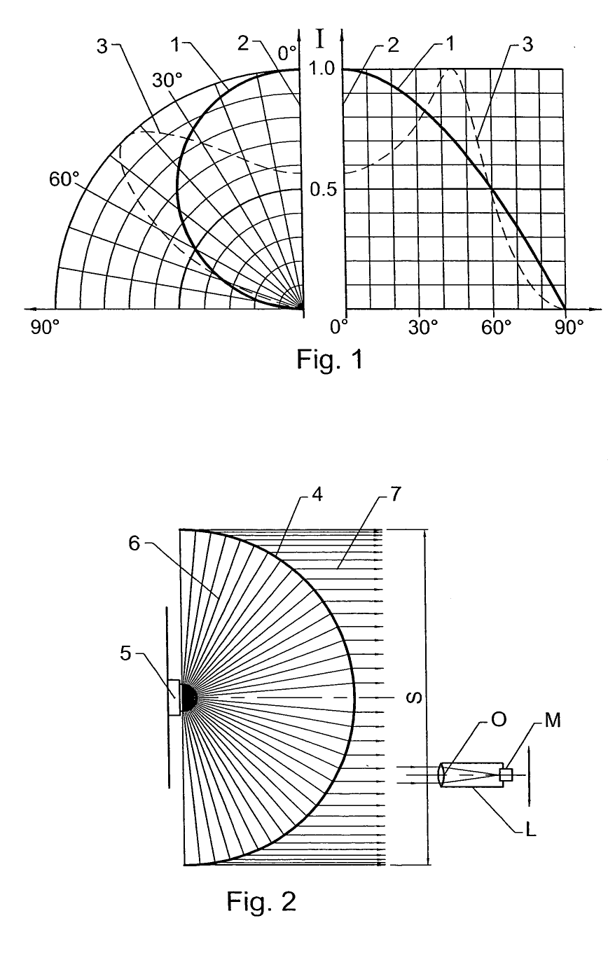

FIG. 1 shows a diagram of a cosine distribution,

FIG. 2 shows a theoretical solution of the task in a schematic view,

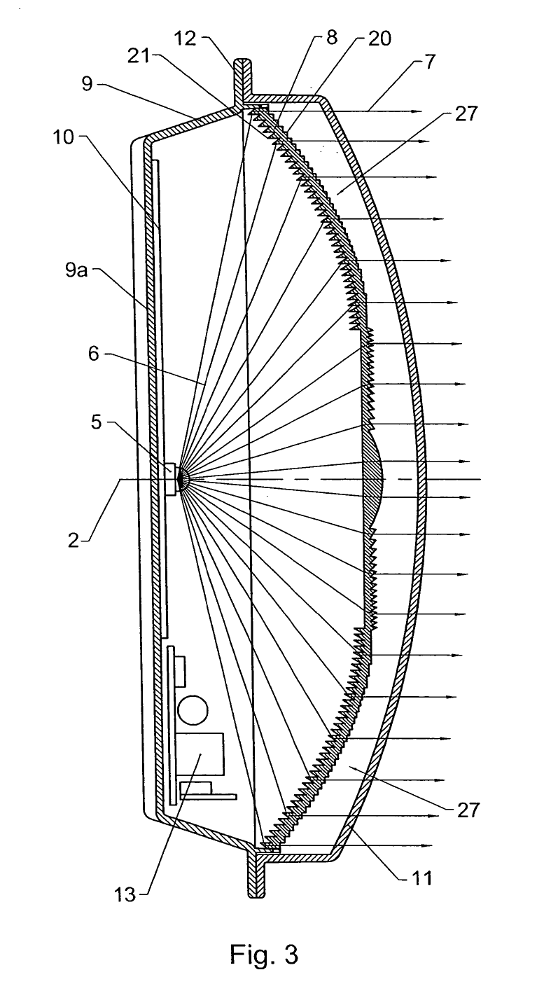

FIG. 3 shows a signal light according to the invention in cross section,

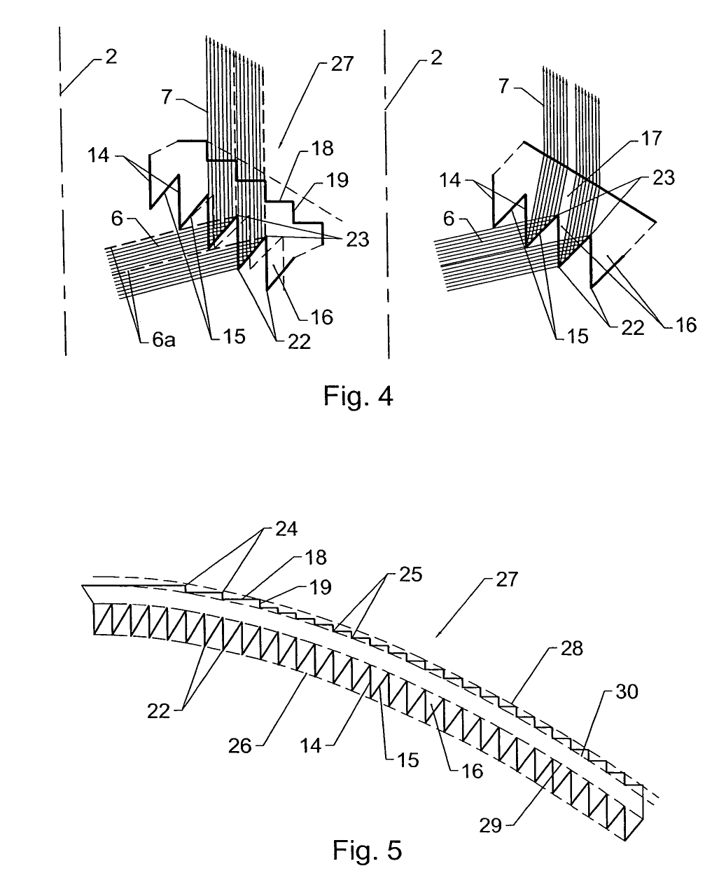

FIG. 4 shows a condenser lens according to the invention in detail (left) and a condenser lens according to the prior art (right),

FIG. 5 shows an enlargement of part of a condenser lens according to the invention, and

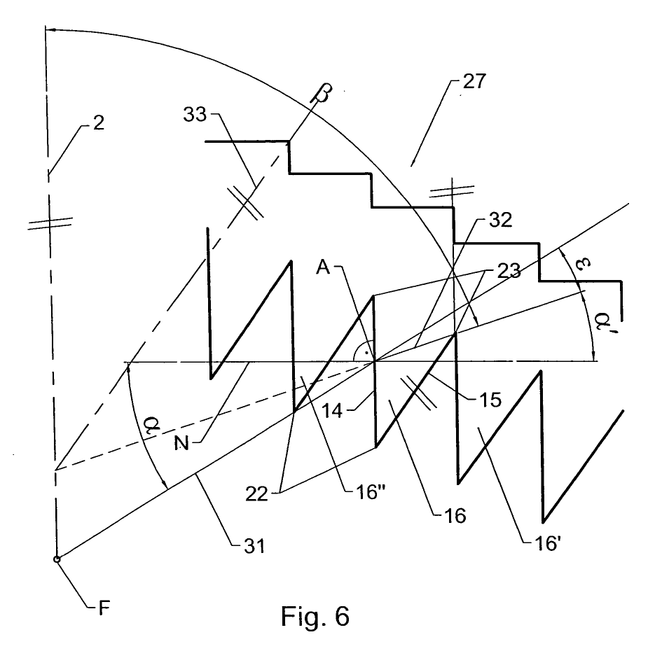

FIG. 6 shows an enlarged part of a condenser lens according to the invention, where the beam path of a boundary light path is shown by means of connection lines and refraction angles.

The relative intensity of a cosine distribution 1 is shown in FIG. 1, in Cartesian coordinates on the right and in a polar plot on the left. The right-hand depiction shows the cosine emission, which has maximum intensity in the optical axis 2, and virtually no more light at 90° relative to the optical axis 2. In the left-hand depiction, the same relation is formed in known fashion by a semicircle. A so-called batwing distribution 3 is also drawn with a dashed line, which has its maximum here at about 43°. This radiation characteristic, together with a flat condenser disk at a radius on the order of the light source spacing, produces a relatively uniform brightness distribution. One problem is that the maximum intensity should fall precisely on the outermost edge of the condenser lens. The subsequent drop in the curve still contains an amount of light that is lost unutilized. If it is at least partially used, by designing the condenser disk with a somewhat larger diameter or reducing the LED spacing, then a much darker edge in appearance is already obtained, because of the very steep light reduction.

FIG. 2 shows the theoretical solution of the problem by means of a hemispherical condenser lens 4, at the center of which is the LED light source 5. It has the same distance to each point of condenser lens 4, and the emitted light beams 6 are directed parallel to optical axis 2 and form the light bundle 7 parallel to the axis. It is apparent that the light beams become increasingly denser toward the edges. However, since they become weaker to the same extent, the brightness remains constant. If deflection of the light beams in condenser lens 4 could be accomplished without loss, one would then have constant brightness over the entire signal surface S.

A light density measurement device L is also shown schematically here. An objective O directs the light of a specific cutout of the signal surface S to a measurement cell M. The instrument is generally moved parallel to the optical axis 2 over the entire signal surface S and determines the brightest and darkest locations.

FIG. 3 shows a light according to the invention with a condenser lens 8 and a light source 5 in cross section arranged at least close to the optical axis 2 of the condenser lens. The center of the condenser lens 8, as shown in FIG. 3, can be designed in the form of a flat condenser disk known to one familiar with the prior art. A converging lens, provided at the center of this flat condenser disk, is surrounded by a region that has the structure of a Fresnel lens, in which, in this case, the Fresnel structure or Fresnel zones are provided on the side facing away from the light source. The design of the center of the condenser lens 8 from FIG. 3 naturally represents merely an embodiment. The special shape of this region is not critical to the essence of the invention. For example, the Fresnel structure, i.e., the beveled or curved steps or teeth, can also be arranged on the side facing the light source. Only a converging lens without an enclosing Fresnel structure can also be provided. Curvature of the lens in this region would also be conceivable.

A region 27, which is curved around the LED light source 5, is connected to the center of the condenser lens 8 from FIG. 3, in which the full 90° is not entirely depicted in this view, but which would be conceivable as an embodiment. In the embodiment depicted in FIG. 3, a limited light intensity is therefore still present at the edges, so that the brightness ratio is significantly improved, without too much light being lost.

Since the condenser lens 8 ends in the region of flange 12, the housing 9 can be tapered conically from flange 12 in the direction of light source 5 and requires no more space than that formerly occupied by a reflector, so that incorporation in existing signaling devices is ensured. The flat housing bottom 9a is occupied by a cooling plate 10, which distributes and gives off the heat from the LED light source 5. The light beams 6, emitted by the LED light source 5, and the geometry chosen in this embodiment (the straight light beams still trapped by the edge of the condenser lens 8 and the connecting line between the light source 5 and the outer edge of the condenser lens 8 form an angle less than 90° with the optical axis) leave room on the edge of the housing 9 for the control electronics 13, which are connected to the light source and control operation of the light. A cover 11 with a flange 12 is sealed tightly to housing 9. It can contain any optical element that produces a desired light distribution from the parallel directed light bundle 7, for example, diverging or converging lenses, prisms, knurled surfaces.

The effect of the invention is explained in detail in FIG. 4. The right-hand figure shows a section of an already known condenser lens, whose edges are curved in the direction toward the light source, and which has a shell shape, the outside of the shell, that is, the side facing away from the light source 5, having a smooth surface. On the inside 20 of the condenser lens, steps or teeth 16 in the form of a sawtooth structure are provided, forming a Fresnel structure. The notches between the teeth end in the notch base 23. This is therefore the section of the reflection surface 15 with the light entry surface 14 of an adjacent tooth 16′. The light beam 6 from the light source 5, for example, an LED, are refracted on the light inlet surfaces 14 of tooth 16 (this can still be seen in FIG. 4, despite the small refraction angle), and are then totally reflected by reflection surfaces 15. After passage through the smooth surface of outside 21, during which they are refracted, the light beams form a light bundle 7 parallel to optical axis 2. However, an unutilized space 17 containing no light beams, and which contributes to darkening of the appearance that increases toward the edge, is then formed between the light bundles that pass through the adjacent teeth 16 of condenser lens 8.

In the left-hand depiction, the light beams 6 from the LED are directed uniformly parallel to optical axis 2 by diffraction on the light inlet surface 14, and are then reflected by the reflection surface 15, because the outlet surfaces 18 according to the invention are flat and perpendicular to the optical axis 2, in which case no change in direction occurs on leaving the condenser lens 8. In order for the wall thickness not to successively increase toward the edge, gradations are provided that are formed by the outlet surfaces 18 and by connection surfaces 19, preferably aligned parallel to optical axis 2. Connection surfaces 19, formed parallel to optical axis 2, therefore represent a preferred variant, since they do not hinder or deflect the parallel light beams of light bundle 7.

In this variant according to the invention, a stronger curvature of the condenser lens 8 can be achieved, which is shown by known the variant drawn with the dashed line. No unutilized intermediate space 17 is form in the condenser lens 8 according to the invention between the light bundles guided through the individual steps 16, so that higher brightness is obtained, especially in the edge region, in comparison with the condenser lens known from the prior art. All light beams 6 are also utilized, and therefore the efficiency is high and unchanging. An optimal geometry of condenser lens 8 is then obtained, if the curvature of the shell in region 27 of condenser lens 8 diminishes toward the edge of the condenser lens 8. A uniform light distribution is guaranteed on this account.

For this purpose, boundary light beams 6a are also drawn, which just miss the light entry surface 14 and continue beyond the edges 22 formed by surfaces 14, 15, only grazing them. They strike the inlet surfaces 14 of the next outer tooth or Fresnel zone 16, are refracted and reflected at the notch base 23 on reflection surface 15, so that maximum efficiency is achieved.

The geometry of the condenser lens must be produced according to this state of affairs, otherwise the Fresnel structure, consisting of steps or teeth 16, can be made arbitrarily dense or large or small. Step sequences that also become gradually larger or smaller can also be produced. Local irregularities in brightness can therefore be compensated for or even intentionally produced.

Limitation surfaces 29, 30 are shown in FIG. 5. The limitation surfaces separate essentially the interior or core of the condenser lens 8 from the tooth structure 16 or step structure 18, 19. The limitation surface 29 contains the individual indentation base 23 of the teeth formed by the light inlet surfaces 14 and the reflection surfaces 15. The limitation surface 30 contains the step inside edges 25 of the gradations 18, 19. In a preferred embodiment, the limitation surfaces 29, 30 are essentially parallel to each other.

The envelope surfaces 26, 28 enclosing the condenser lens 8 are also shown in FIG. 5. The envelope surface 26 contains the tooth edges 22 of teeth 16 and the envelope surface 28 contains the outer step edges 24 of gradations 18, 19. Another possible embodiment consists merely of the fact that the envelope surfaces 26, 28 are essentially parallel to each other.

With the feature of gradations and parallel limitation surfaces 29, 30 and/or envelope surfaces 26, 28, the condenser lens 8 according to the invention can be produced in material-saving fashion, on the one hand, and the light loss in the lens body is limited and kept constant over the entire lens, on the other.

In the case of production by plastic injection molding, the distance between the envelope surface 26 and the limitation surface 29, i.e., the tooth height, but at least the tooth width, i.e., the distance between two adjacent indentation bases 23, should be less than or equal to the distance between the two limitation surfaces 29, 30, in order to avoid technical problems.

The beam path of a boundary light beam is shown in FIG. 6, and with it, the geometry of the condenser lens 8 is explained. The connecting line 31 between the focal point F of condenser lens 8 and a tooth edge 22″ of a tooth 16″ intersects in its extension the light entry surface 14 of an adjacent tooth 16 at boundary entry point A. The line 32 corresponds to the refracted light beam, and its angle α′, to the perpendicular N through A, is determined according to Snell's law of refraction and the refractive index of the two adjacent materials n₁, n₂. Line 32 forms an angle ε with the connecting line 31. Angle ε is the difference between the angle of incidence α and the angle of refraction α′. The angle of incidence α and the angle of refraction α′ are measured from the perpendicular N of the light entry surface 14 and linked to each other by Snell's law of refraction: n₁ sin(α)-n₂ sin(α′), where n₁ represents the refractive index of the surroundings, which amounts to about 1 for air, and n₂ is the refractive index of the condenser lens and material. The angle of refraction α′ can therefore be represented in the form: α′=arcsin (sin(α)×n₁/n₂). It is now important for the condenser lens 8, according to the invention, that the line 32 or the refracted boundary light beam pass through the indentation base 23, which is formed by the reflection surface 15 and by the light entry surface 14 of the adjacent tooth 16′ in a direction away from the optical axis 2, or at least intersect in the immediate vicinity of reflection surface 15, so that the boundary light beam is still totally reflected by reflection surface 15, so that the intermediate spaces 17 mentioned in the introduction do not occur.

The reflection surface is sloped so that the total reflecting boundary light beam 6a runs parallel to optical axis 2. It therefore lies parallel to the angle bisector 33 of slope angle β, which occurs between the refracted beam directly 32 and the optical axis 2. Its intersection with the entry surface 14 produces an intersection edge 22 that is necessary to establish the geometry of the next outer tooth 16′.

This type of condenser lens is therefore characterized by the fact that the line 32, passing through a boundary entry point A of light entry surface 14 of a tooth 16 and forming an angle ε with connecting line 31, also intersects the indentation base 23 of the tooth formed by the reflection surface 15 and the light entry surface 14 of an adjacent tooth 16′ in a direction away from the optical axis 2, or at least intersects the reflection surface 15 in the immediate vicinity of indentation base 23, in which the connecting line 31 passes through the focal point F and through the tooth edge 22 of the adjacent tooth 16″ toward optical axis 2, and the light entry point A is the intersection point of the connection line 31 with the light entry surface 14 and the angle ε is the difference between angle of incidence α and angle of refraction α′, where the angle of incidence α is the angle between the connecting line 31 and the perpendicular N of the light entry surface 14, and the angle of refraction ′ is given by arcsin (sin(α)×n₁/n₂), where n₁, is the refractive index of the surroundings, which, in the case of air, is essentially 1, and n₂ is the refractive index of the condenser lens material.

Naturally, a geometry would also be possible in which the boundary light beam 6a falls on reflection surface 15 farther away from indentation base 23. However, it is advantageous if the reflection surface 15 is fully utilized, since stronger curvature of the condenser lens 8 is thereby possible.

As is apparent from FIGS. 3 and 4, both sides of a condenser lens 8 can be released from the mold without problem in the direction of optical axis 2. The stepped structure of the outlet surface 18 is much simpler to produce than the reflection structure, and therefore production of the mold poses no additional difficulty.

As is also apparent from FIGS. 3 and 4, it is recommended for practical reasons to make the inlet surfaces 14 flush with the connection surfaces 19. After production, the tips and edges have a slight radius, which has a negative effect on light quality and produces a certain amount of scattered light. Because of the flush arrangement, edge errors of the two structures are congruent, so that less scattered light overall is produced.

In another embodiment of the invention, light-guiding optical elements, for example, lenses, prisms, knurled surfaces, etc., can be mounted already on the flat outlet surfaces 18 or connected to them from the outset in one piece. On the one hand, they pursue the objective of creating appropriate patterns that are perceived as pleasant by the human eye, and, on the other hand, divergences of edge or boundary beams can be corrected by such elements.

These elements have the advantage that they can operate without distortion. Diffusing elements in the cover 11 in the shape of a spherical cap must also take the curvature into consideration.

The figures show a rotationally symmetrical variant of condenser lens 8. The entry surfaces 14 and the connection surfaces 19 are designed as a circular cylinder, the reflection surfaces 15 are conical surfaces. However, other geometries, for example, elliptical, rectangular, etc., or with freely chosen contours according to the same configuration principles, can also be made.

It is naturally also possible to achieve higher uniformity of brightness by changing the characteristics of the LED radiation, for example, by small adapter optics. Untrapped outermost light fractions can also be directed against the condenser disk by incomplete enclosure of the light source, so that all the light is utilized. The design of the condenser lens according to the invention yields much better results in practice than, for example, a flat condenser lens during use of a batwing distribution, because its equalizing effect overlaps and the efficiency is better, because of almost complete light utilization.

Deviating from the depictions in the drawing, the LED light source 5 can also consist of several individual LEDs that are arranged in the highest packing density. The off-center LEDs produce light beam bundles that deviate slightly from being parallel to the axis according to optical principles. Some such light beams can graze the inlet and connection surfaces parallel to the axis from the inside and are totally reflected there, which, overall, does not have an effect on either efficiency or light distribution. Only a very limited fraction strikes the connection surfaces 19 from the outside and is partly reflected there and partly absorbed. Only this slightly absorbed light fraction is lost, but by local sloping of the outlet surface 18 in the region of the stepped inside edge 25, it can be diverted so that it emerges at least parallel to the optical axis 2 and does not impinge on the connection surfaces 19. Equally high efficiency, but with smaller light bundling, is therefore also possible for such light sources with several LEDs.

Use of the condenser lens according to the invention, as well as its use in lights, is not restricted to traffic signals. All possible lights that must yield a readily visible signal, and especially bundled light, are considered for its application, for example, headlights, projectors, lights in lighthouses, table lamps, etc.

1. Condenser lens for production of essentially parallel light beams, in which the condenser lens (8) curves essentially in the form of a shell about its focal point (F) and has, at least in a region (27) on the inside (20) of the shell, a Fresnel structure in the form of teeth (16) that are bounded by light entry surfaces (14) and reflection surfaces (15), characterized by the fact that, in region (27), the outside (21) of the shell has gradations formed from outlet surfaces (18) and connection surfaces (19), the outlet surfaces (18) being aligned essentially normal and the connecting surfaces (19) that connect the adjacent outlet surfaces (18) being aligned essentially parallel to optical axis (2).

2. Condenser lens according to claim 1, characterized by the fact that by the arrangement and slope of the reflection surface (15) of a Fresnel tooth (16), an imaginary boundary light beam (6a) issuing from focal point (F) and touching the tooth edge (22) of the preceding tooth (16″), after refraction on the inlet surface (14), touches the indentation base (23) or strikes the reflection surface (15) in its immediate vicinity and runs parallel to optical axis (2) after reflection.

3. Condenser lens according to claim 1, characterized by the fact that the light inlet surfaces (14) of tooth (16) are aligned parallel to optical axis (2).

4. Condenser lens according to claim 1, characterized by the fact that for each gradation (18, 19) on outside (21), at least one tooth (16) of the Fresnel structure is provided on the inside (20).

5. Condenser lens according to claim 1, characterized by the fact that the connecting surfaces (19) and the light entry surfaces (14) are flush with each other.

6. Condenser lens according to claim 1, characterized by the fact that the stepped inside edges (25), formed by the outlet surfaces (18) and the connecting surfaces (19), and the indentation bases (23), formed by the light entry surfaces (14) and reflection surfaces (15), each lie on a limitation surface (29, 30), the limitation surfaces (29, 30) being essentially parallel to each other.

7. Condenser lens according to claim 1, characterized by the fact that the stepped outside edges (24), formed by the outlet surfaces (18) and connection surfaces (19), and the tooth edges (22), formed by the light entry surfaces (14) and reflection surfaces (15), each lie on an envelope surface (26, 28), the envelope surfaces (26, 28) being essentially parallel to each other.

8. Condenser lens according to claim 6, characterized by the fact that the distance between the envelope surface (26) and the limitation surfaces (29) is less than or equal to the distance between the two limitation surfaces (29, 30).

9. Condenser lens according to claim 6, characterized by the fact that the distance between two adjacent indentation bases (23) is less than or equal to the distance between the two limitation surfaces (29, 30).

10. Condenser lens according to claim 1, characterized by the fact that the curvature of the condenser lens (8) diminishes in region (27) toward the edge of condenser lens (8).

11. Condenser lens according to claim 1, characterized by the fact that on at least one light inlet surfaces (14) and/or at least one outlet surface (18), an optical structure, like a lens, for example, a converging lens or a diverging lens, prisms, a knurled surface, etc., are provided for further light guidance.

12. Condenser lens according to claim 1, characterized by the fact that the condenser lens (8) is rotationally symmetrical relative to optical axis (2).

13. Condenser lens according to claim 1, characterized by the fact that it is formed from transparent plastic.

14. Light for generation of essentially parallel light beams, in which the light includes at least one preferably point-like light source (5), for example, an LED, and a condenser lens (8), in which the light sources (5) is arranged at least close to focal point (F) of condenser lens (8), and in which the condenser lens (8) curves essentially in the form of a shell about focal point (F) and has a Fresnel structure in the form of teeth (16) that are bounded by the light inlet surfaces (14) and reflection surfaces (15), at least in one region (27) on the inside (20) of the shell, characterized by the fact that in region (27) the outside (21) of the shell has gradations formed by outlet surfaces (18) and connecting surfaces (19), the outlet surfaces (18) being aligned essentially normal and the connection surfaces (19) that connect the adjacent outlet surfaces (18) being aligned essentially parallel to the optical axis (2).

15. Light according to claim 14, characterized by the fact that by the position and slope of the reflection surfaces (15) of a Fresnel tooth (16), a boundary light beam (6a), coming from the focal point (F) and touching the tooth edge (22) of the preceding tooth, after refraction on inlet surface (14), touches the indentation base (23) or encounters the reflection surface (15) in its immediate vicinity and runs parallel to the optical axis (2) after reflection.

16. Light according to claim 14, characterized by the fact that the light source (5) sits on a bottom (9a) of a housing (9), in which a transparent cover (11) is provided for housing (9), and that the edge of the condenser lens (8) is arranged between housing (9) and cover (11), preferably in the region, in which housing (9) and cover (11) are in contact with each other.

17. Light according to claim 16, characterized by the fact that the cover (11) is fastened to housing (9) by means of a flange connection (12).

18. Light according to claim 16, characterized by the fact that the housing (9) tapers toward bottom (9a).

19. Light according to claim 18, characterized by the fact that the bottom (9a) is flat.

20. Light according to claim 16, characterized by the fact that the cross section defined by the outer edge of condenser lens (8) has essentially the same shape and size as the cross section defined by the edge of cover (11).

21. Light according to claim 16, characterized by the fact that optical elements, for example, a diverging lens, a converging lens, knurling, prisms, etc., are integrated in the cover (11).

22. Light according to claim 16, characterized by the fact that a cooling plate (10) for heat removal is provided beneath light source (5).
